(19) United States
(12) Patent Application Publication
(10) Pub. No.: US 2014/0236819 A1
(43) Pub. Date: Aug. 21, 2014

(54) Payment System For Issuing And Depositing Paperless Checks

(71) Applicant: BANK OF AMERICA CORPORATION, Charlotte, NC (US)

(72) Inventor: Sanjay D. Pillay, Round Rock, TX (US)

(73) Assignee: Bank of America Corporation, Charlotte, NC (US)

(21) Appl. No.: 13/769,564

(22) Filed: Feb. 18, 2013

(51) Int. Cl. G06Q 20/10

(52) U.S. Cl. CPC G06Q 20/108
USPC 705/42

(57) ABSTRACT

A method for issuing paperless checks includes receiving a check request from a first computing device associated with a payer. The check request identifies a payee to receive a monetary amount but does not include any account information associated with the payee. In response to the check request, a paperless check is transmitted to the payee. A deposit request is received from a second computing device associated with the payee. The deposit request includes account information associated with the payee and requests deposit of the paperless check. The deposit request is validated and the monetary amount is electronically transferred from a first account associated with the payer to a second account associated with the payee.

### TECHNICAL FIELD OF THE INVENTION

The present invention relates generally to the field of payment systems and more particularly to a system and method for issuing and depositing paperless checks.

### BACKGROUND OF THE INVENTION

Various methods of payment are available for transferring money from one person to another. For example, where a person is an account holder associated with a financial institution, the issuing party may issue a check, cash letter, or other physical form of payment. Where such a payment is received, the receiving party must present and surrender the physical form of payment at a financial institution that is associated with the receiving party, the issuing party, or a third-party that performs check-cashing services. Physical forms of payment such as this are convenient in that the issuing party is not required to have knowledge of any financial information associated with the receiving party. However, checks and other physical forms of payment are frequently lost or stolen before they can be deposited into the receiving party's account.

As an alternative, an issuing party may issue an electronic transfer of funds that is directly deposited into the receiving party's account. In such a scenario, funds are transferred directly from the issuing party's account into the receiving party's account. However, this form of payment requires the issuing party to provide an account number or other identifying information associated with the receiving party. Additionally, many financial institutions will only authorize such transactions where both parties are account holders within the financial institution. Or such transfers require you to be registered with a third party serving as an agent for the transfer. Accordingly, electronic fund transfers may not be possible where the issuing party does not know the account number of the receiving party or where the receiving party is not affiliated with the issuing party's financial institution.

### SUMMARY OF THE DISCLOSURE

In accordance with the present invention, disadvantages and problems associated with making electronic payments may be reduced or eliminated.

According to one embodiment, a method for issuing paperless checks includes receiving a check request from a first computing device associated with a payer. The check request identifies a payee to receive a monetary amount but does not include any account information associated with the payee. In response to the check request, a paperless check is transmitted to the payee. A deposit request is received from a second computing device associated with the payee. The deposit request includes account information associated with the payee and requests deposit of the paperless check. The deposit request is validated and the monetary amount is electronically transferred from a first account associated with the payer to a second account associated with the payee.

Certain embodiments of the invention may provide one or more technical advantages. A technical advantage of one embodiment may be that the invention provides financial institutions and their account holders with a mechanism for the electronic transfer of funds in a manner that is similar to paper checks but more readily compliments a direct deposit. For example, customers of a financial institution may issue paperless checks that are transmitted to a receiving party via the Internet. In certain embodiments, customers may issue paperless checks using a mobile device such as a smart phone or other personal data assistant. As an additional advantage, certain embodiments allow the recipient of the funds to control when and where they are deposited in a manner similar to a conventional paper check. Still another advantage may be that certain embodiments do not require the issuing party to provide or even have knowledge of the receiving party's bank account. As a result, fraud relating to the misuse or misappropriation of account information may be prevented. Still another technical advantage of an embodiment may be that, because the issued checks are paperless, there is less chance of the funds being lost or stolen. Additionally, security measures may be in place to prevent the fraudulent receipt and cashing of the paperless checks.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a payment system that facilitates the issuance and deposit of paperless checks;

FIG. 2 illustrates a particular embodiment of payment logic that facilitates the issuance and deposit of paperless checks;

FIGS. 3A-3B are diagrams that illustrate a method for the issuance and deposit of paperless checks; and

FIGS. 4A-4E illustrates example GUIs that facilitate input by users for the purpose of issuing and depositing paperless checks.

### DETAILED DESCRIPTION OF THE DRAWINGS

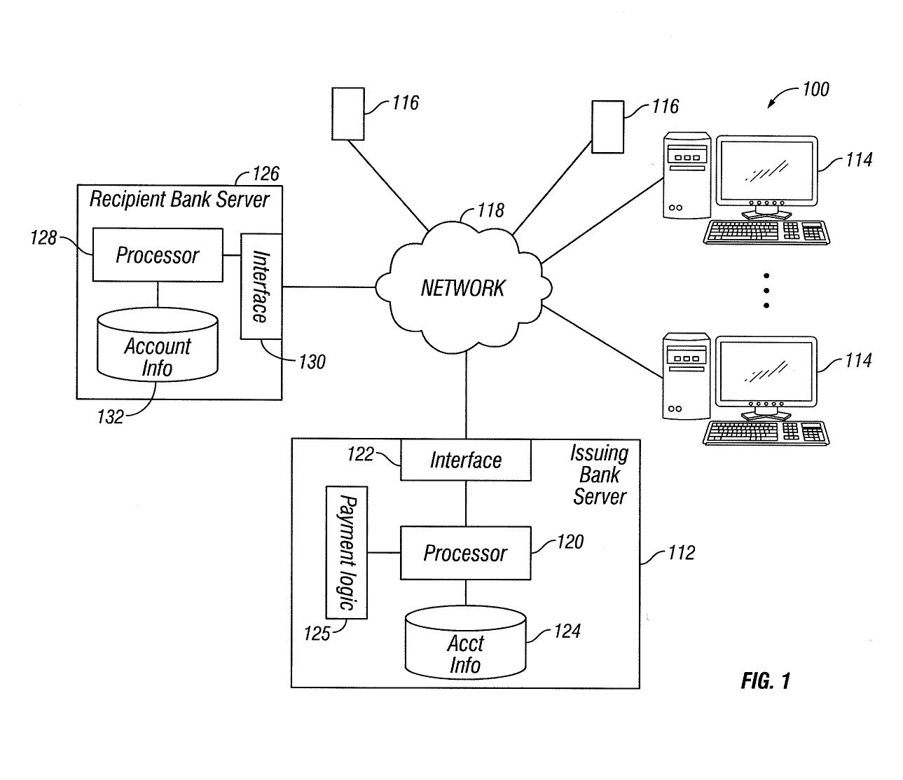

FIG. 1 illustrates an example payment system 100 that facilitates the issuance and deposit of paperless checks. Payment system 100 includes an issuing bank server 112, which communicates with one or more workstations 114 and one or more mobile devices 116 over network 118. Issuing bank server 112 includes a processor 120, which is communicatively coupled to a network interface 122 and a memory 124. In particular embodiments, payment system 100 also includes a recipient bank server 126. Similar to issuing bank server 112 may include a processor 128 that is communicatively coupled to a network interface 130 and a memory 132.

In particular embodiments, issuing bank server 112 may be a financial institution with whom a user of any one of workstations 114 or mobile devices 116 maintains an account. The user, as a payer, may use workstation 114 or mobile device 116 to request issuing bank server 112 to issue a paperless check or cash letter to another user, a payee, of payment system 100. In response to the request of the payer, issuing bank server 112 may then operate to issue the paperless check to the other user. After receiving the paperless check, the receiving party, as the payee, may then use any one of workstations 114 or mobile devices 116 to transmit a deposit request. The deposit request may include account information associated with the payee. Issuing bank server 112 may then transfer funds from an account 124 associated with the payer to an account 132 associated with the payee.

Because the check is issued electronically and is paperless, there is less chance that the check will be lost, stolen, or misused. Additionally, issuing bank server 112 may not require that the payer provide or have knowledge of any financial information associated with the payee. For example, the payer need not know an account number or the name of the financial institution with which the payee maintains an account. Additionally, similar to a conventional check, the payee maintains control over when and where the funds are deposited. Security measures may require validation of the paperless check, the payee, and/or an account of the payee before funds are transferred to the payee's account 132.

According to the illustrated embodiment, payment system 100 includes workstations 114 and mobile devices 116 that communicate with issuing bank server 112 through network 118. Mobile devices 116 may be cellular or mobile phones, pagers, tablet computers, electronic notebooks, Personal Digital Assistants (PDAs), minicomputers, laptop computers, or any other suitable device (wireless, wireline, or otherwise), component, or element capable of receiving, processing, storing, and/or communicating information with other components of payment system 100. Mobile devices 116 may also comprise any suitable user interface such as a display, microphone, speaker, keyboard, or any other appropriate terminal equipment usable by a user of payment system 100. Payment system 100 may comprise any suitable number and combination of mobile devices 116.

Mobile devices 116 may include any suitable hardware or software that may be used to remotely connect to network 118 to interact with issuing bank server 112 and/or recipient bank server 126 for the management of financial accounts. For example, a mobile device 116 such as a smart phone may include an application for initiating a communication session between the smart phone and issuing bank server 112. In a particular embodiment, the application may be an internet browser that may be directed to a Uniform Resource Locator of a website that is associated with and/or maintained by issuing bank server 112. In an another embodiment, the application may be a specialized application that establishes a direct connection with issuing bank server 112. In operation, a user that maintains an account with a financial institution associated with issuing bank server 112 may use smart phone to communicate requests and other electronic communications related to payments to be issued and/or payments to be received. For example, a payer may use mobile device 116 to request issuing bank server 112 to issue a paperless check to another user of payment system 100. As another example, a payee may use mobile device 116 to request validation and/or deposit of a paperless check.

In a similar manner, workstations 114 may also be used for transmitting and receiving communications related to paperless checks and other payments. Workstations 114 may include a desktop computer system, a laptop or notebook computer system, an interactive kiosk, a mainframe, a mesh of computer systems, a netbook computer system, a server, a tablet computer system, or a combination of two or more of these. one or more laptops, personal computers, monitors, display devices, servers, user input devices, or other suitable computing devices for enabling user input.

In particular embodiments, workstations 114 may include hardware, software, or embedded logic components or a combination of two or more such components for carrying out the appropriate functionalities implemented or supported by workstations 114. In a particular embodiment, a workstation 114 may enable its user to communicate with other users at other workstations 114 or mobile devices 116. Additionally, a workstation 114 may enable its user to communicate with either or both of issuing bank server 112 and recipient bank server 126. For example, workstations 114 may have a web browser, such as MICROSOFT INTERNET EXPLORER or MOZILLA FIREFOX, and may have one or more add-ons, plug-ins, or other extensions, such as GOOGLE TOOLBAR or YAHOO TOOLBAR. In one example embodiment, a user of workstation 114 may enter a Uniform Resource Locator of a website that is associated with and/or maintained by issuing bank server 112 or recipient bank server 126. In various embodiments, workstations 114 may be used to communicate requests and other electronic communications related to payments to be issued and/or received. For example, a payer may use workstation 114 to request issuing bank server 112 to issue a paperless check to another user of payment system 100. As another example, a payee may use workstation 114 to request validation and/or deposit of a paperless check.

Network 118 represents any suitable network operable to facilitate communication between the components of payment system 100. Network 118 may include any interconnecting system capable of transmitting audio, video, signals, data, messages, or any combination of the preceding. Network 118 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, an extranet, or any other suitable communication link, including combinations thereof operable to facilitate communication between the components. Network 118 may include one or more networks 118.

Issuing bank server 112 represents any suitable components that facilitate the issuance of paperless checks, payment letters, or other payments in system 100. In one particular embodiment, issuing bank server 112 may be associated with a bank, credit card company, credit union, or other financial institution that handles credit accounts, debit accounts, checking accounts, savings accounts, etc. Issuing bank server 112 may include a network server, remote server, mainframe, host computer, workstation, web server, personal computer, file server, or any other suitable device operable to communicate with workstations 114, mobile devices 116, and recipient bank server 126. In some embodiments, issuing bank server 112 may execute any suitable operating system such as IBM's zSeries/Operating System (z/OS), MS-DOS, PC-DOS, MAC-OS, WINDOWS, UNIX, OpenVMS, Linux or any other appropriate operating systems, including future operating systems. The functions of issuing bank server 112 may be performed by any suitable combination of one or more servers or other components at one or more locations. The servers may be public or private servers, and each server may be a virtual or physical server. The servers may include one or more servers at the same or at remote locations. Also, issuing bank server 112 may include any suitable component that functions as a server.

In the illustrated embodiment, issuing bank server 112 includes network interface 122, processor 120, memory 124, and payment logic 125. Network interface 122 represents any suitable device operable to receive information from network 118, transmit information through network 118, perform suitable processing of the information, communicate to other devices, or any combination of the preceding. Specifically, network interface 122 may receive payment data associated with payments requests from workstations 114, mobile devices 116, and recipient bank server 126. For example, network interface 122 may receive a payment request from a payee using a workstation 114 or mobile device 116. As will be described in more detail below, the payment request may include a payee identifier, a payment amount, a payer identifier, and/or any other suitable data relating to the payment request. As another example, network interface 122 may receive a deposit request from a payee using a workstation 114 or mobile device 116. As will be described in more detail below, the deposit request may include a payee identifier, a deposit amount, a payer identifier, a unique key, and/or any other suitable data relating to deposit request. As still another example, network interface 122 may communicate payment information to recipient bank server 126 to effect the transfer of funds for a deposit. Network interface 122 represents any port or connection, real or virtual, including any suitable hardware and/or software, including protocol conversion and data processing capabilities, to communicate through a LAN, WAN, or other communication system that allows issuing bank server 112 to exchange information with network 118, workstations 114, mobile devices 116, recipient bank server 126, or other components of system 100.

Processor 120 communicatively couples to network interface 122 and memory 124 and controls the operation and administration of issuing bank server 112 by processing information received from network interface 122 and memory 124. Processor 120 includes any hardware and/or software that operates to control and process information. For example, processor 120 executes payment logic 125 to control the operation of issuing bank server 112. Processor 120 may be a programmable logic device, a microcontroller, a microprocessor, any suitable processing device, or any suitable combination of the preceding.

Memory 124 stores, either permanently or temporarily, data, operational software, or other information for processor 120, other components of issuing bank server 112, or other components of payment system 100. Memory 124 includes any one or a combination of volatile or nonvolatile local or remote devices suitable for storing information. For example, memory 124 may include random access memory (RAM), read only memory (ROM), flash memory, magnetic storage devices, optical storage devices, network storage devices, cloud storage devices, or any other suitable information storage device or a combination of these devices. While illustrated as including particular modules, memory 124 may include any suitable information for use in the operation of issuing bank server 112.

In the illustrated embodiment, memory 124 includes a data store that stores account information associated with account holders. The account information may include various types of information or data that is organized in any suitable manner. In other embodiments, the account data stored in memory 124 may be organized according to specific data structures. Accordingly, the contents of memory 124 may be stored as a dimensional, flat, hierarchical, network, object-oriented, relational, XML, or other suitable database or a combination or two or more of these.

In a particular embodiment, the account information stored in memory 124 may include names, dates, account numbers, addresses, amounts, institutions, groups, or any other information associated with an account. Although the illustrated embodiment depicts account information being stored in memory 124, the account information may be stored in one or more other components of payment system 100 in place of or in addition to memory 124. For example, in one embodiment, the account information may be stored in a remote database and retrieved by issuing bank server 112 through network 118 as needed during payment processing. In another embodiment, issuing bank server 112 may retrieve account information from a remote database and store it in a local cache, such as memory 124, to allow for faster access.

Payment logic 125 represents any suitable set of instructions, logic, or code embodied in a computer-readable storage medium and operable to facilitate the operation of issuing bank server 112 while processing payment and deposit requests. For example, payment logic 125 may include rules and instructions for issuing paperless checks in response to payment requests. Payment logic 125 may be stored in memory 124 or another memory associated with issuing bank server 112. Payment logic 125, or portions thereof, may also be embodied in hardware associated with issuing bank server 112 or other components of payment system 100. Furthermore, the components of payment logic 125 may be stored in the same or different memories. Components of payment logic 125 may also be stored in different components of payment system 100. Various portions of the components of payment logic 125 may be similarly stored in the same or different components of payment system 100.

Recipient bank server 126 represents any suitable components that facilitate the deposit of paperless checks, payment letters, or other payments in system 100. In one particular embodiment, recipient bank server 126 may be associated with a bank, credit card company, credit union, or other financial institution that handles credit accounts, debit accounts, checking accounts, savings accounts, etc. Recipient bank server 126 may include a network server, remote server, mainframe, host computer, workstation, web server, personal computer, file server, or any other suitable device operable to communicate with workstations 114, mobile devices 116, and issuing bank server 112. In some embodiments, recipient bank server 126 may execute any suitable operating system such as IBM's zSeries/Operating System (z/OS), MS-DOS, PC-DOS, MAC-OS, WINDOWS, UNIX, OpenVMS, Linux or any other appropriate operating systems, including future operating systems. The functions of recipient bank server 126 may be performed by any suitable combination of one or more servers or other components at one or more locations. The servers may be public or private servers, and each server may be a virtual or physical server. The servers may include one or more servers at the same or at remote locations. Also, recipient bank server 126 may include any suitable component that functions as a server.

In the illustrated embodiment, recipient bank server 126 includes network interface 130, processor 128, and memory 132. Network interface 130 represents any suitable device operable to receive information from network 118, transmit information through network 118, perform suitable processing of the information, communicate to other devices, or any combination of the preceding. Specifically, network interface 130 may receive deposit data associated with a paperless check issued by issuing bank server 112. For example, network interface 130 may receive a deposit request associated with an account holder that is affiliated with recipient bank server 126. As will be described in more detail below, the deposit request may include a payee identifier, a payment amount, and/or any other suitable data relating to the payment request. Network interface 130 represents any port or connection, real or virtual, including any suitable hardware and/or software, including protocol conversion and data processing capabilities, to communicate through a LAN, WAN, or other communication system that allows recipient bank server 126 to exchange information with network 118, workstations 114, mobile devices 116, issuing bank server 112, or other components of system 100.

Processor 128 communicatively couples to network interface 130 and memory 132 and controls the operation and administration of recipient bank server 126 by processing information received from network interface 130 and memory 132. Processor 128 includes any hardware and/or software that operates to control and process information. For example, processor 128 executes deposit logic 134 to control the operation of recipient bank server 126. Processor 128 may be a programmable logic device, a microcontroller, a microprocessor, any suitable processing device, or any suitable combination of the preceding.

Memory 132 stores, either permanently or temporarily, data, operational software, or other information for processor 128, other components of recipient bank server 126, or other components of payment system 100. Memory 132 includes any one or a combination of volatile or nonvolatile local or remote devices suitable for storing information. For example, memory 132 may include random access memory (RAM), read only memory (ROM), flash memory, magnetic storage devices, optical storage devices, network storage devices, cloud storage devices, or any other suitable information storage device or a combination of these devices. While illustrated as including particular modules, memory 132 may include any suitable information for use in the operation of recipient bank server 126.

In the illustrated embodiment, memory 132 includes a data store that stores account information associated with account holders. The account information may include various types of information or data that is organized in any suitable manner. In other embodiments, the account data stored in memory 132 may be organized according to specific data structures. Accordingly, the contents of memory 132 may be stored as a dimensional, flat, hierarchical, network, object-oriented, relational, XML, or other suitable database or a combination or two or more of these.

In a particular embodiment, the account information stored in memory 132 may include names, dates, account numbers, addresses, amounts, institutions, groups, or any other information associated with an account. Although the illustrated embodiment depicts account information being stored in memory 132, in other embodiments the account information may be stored in one or more other components of payment system 100 in place of or in addition to memory 132. For example, in one embodiment, the account information may be stored in a remote database and retrieved by recipient bank server 126 through network 118 as needed during payment processing. In another embodiment, recipient bank server 126 may retrieve account information from a remote database and store it in a local cache, such as memory 132, to allow for faster access.

A component of payment system 100 may include an interface, logic, memory, and/or other suitable element. An interface receives input, sends output, processes the input and/or output, and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory, tangible media, such as a computer readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to payment system 100 without departing from the scope of the invention. For example, payment system 100 may implement perfection procedures different from or in addition to those describe herein. As another example, issuing bank servers 112 may operate in parallel to facilitate the issuance of paperless checks and their subsequent deposit. As yet another example, system 100 may include any number of workstations 114, mobile devices 116, networks 118, issuing bank servers 112, and recipient bank servers 126. Similarly, banks servers 112 and 126 may include any number of interfaces, processors, and memories. Any suitable logic may perform the functions of payment system 100 and the components within payment system 100.

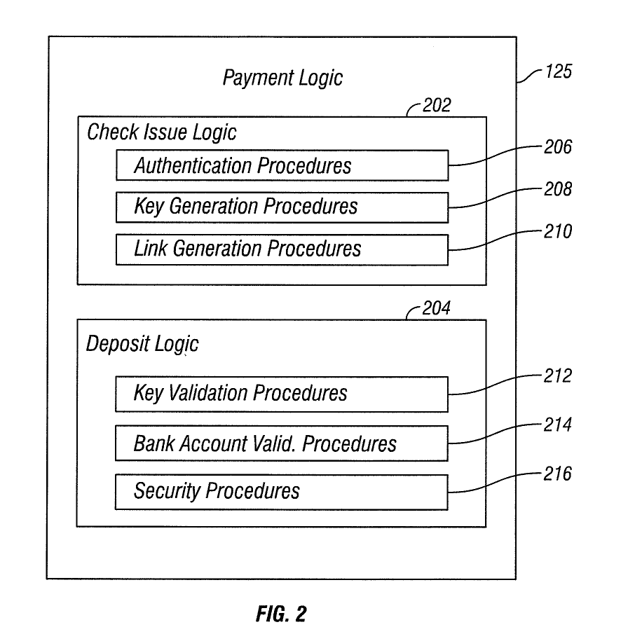

FIG. 2 illustrates a particular embodiment of payment logic 125, which facilitates the issuance and deposit of paperless checks. Payment logic 125 includes check issue logic 202 and deposit logic 204. Check issue logic 202 includes authentication procedures 206, key generation procedures 208, and link generation procedures 210. Deposit logic 204 includes key validation procedures 212, bank account validation procedures 214, and security procedures 216.

Authentication procedures 206 represent any suitable set of instructions, logic, or code embodied in a computer-readable storage medium or any other suitable information that operate to facilitate the authentication of a user. For example, when an account holder of an account maintained by issuing bank server 112 establishes a communication session with issuing bank server 112, the account holder may be required to provide login information or other identifying information that can be used to authenticate the account holder. In one particular embodiment, for example, the issuing bank server 112 may receive a user name and password combination from the account holder. Authentication procedures 206 may operate to authenticate the user as an account holder. Additionally, the login or other user information may be used to identify a particular account 124 maintained by issuing bank server 112.

Key generation procedures 208 represent any suitable set of instructions, logic, or code embodied in a computer-readable storage medium or any other suitable information that operate to facilitate the generation of a unique key for the account holder. For example, in response to receiving a request for a paperless check from an account holder, key generation procedures may operate to generate a unique key that will be associated with a transaction and/or an account of the account holder. In a particular embodiment, the unique key may include a string of digits that may include any unique combination of numerals, letters, or symbols. For example, the unique key may include a string of eight to twelve digits. The key generation procedures may operate to store the unique key such that it is associated with a checking or savings account of the account holder. For example, key generation procedures may cause the unique key to be stored in memory 124 in such a way that it may be correlated with a particular account or account holder. In particular embodiments, the key generation procedures may also operate to transmit the unique key to the account holder, who becomes the payer in the transaction. In other embodiments, the unique key may be transmitted to a user that the payer has been identified as the payee in the transaction.

Link generation procedures 210 represent any suitable set of instructions, logic, or code embodied in a computer-readable storage medium or any other suitable information that operate to facilitate the generation of a communication link to be activated by the payee. For example, in response to receiving a request for a paperless check from an account holder, link generation procedures may operate to generate a web address that is uniquely associated with the paperless check request received from the payer. In particular embodiments, the web address comprises a Uniform Resource Locator of a webpage that is associated with and/or maintained by issuing bank server 112. Link generation procedures 210 may operate to store the web page and/or the link associated with the web page in memory 124. In particular embodiments, the link generation procedures 210 may also operate to transmit the communication link to the payee of the transaction. In other embodiments, the unique key may be transmitted to the payer so that the payer can transmit the link to the payee.

Key validation procedures 212 represent any suitable set of instructions, logic, or code embodied in a computer-readable storage medium or any other suitable information that operate to facilitate the validation of the unique key after it is received from the payee of the transaction. For example, in response to receiving a deposit request from the payee of the paperless check, key validation procedures may operate to match the unique key provided by the payee with the unique key that was stored in memory 124. More specifically, data associated with the payer's account in memory 124 may be retrieved, and the unique key provided by the payee may be matched with the unique key that was stored in the payer's account. Where the key validation procedures 212 are able to match the two keys, key validation procedures 212 may validate the deposit request. Conversely, where the key validation procedures 212 are not able to match the two keys, key validation procedures 212 may operate to invalidate or reject the deposit request.

Bank account validation procedures 214 represent any suitable set of instructions, logic, or code embodied in a computer-readable storage medium or any other suitable information that operate to facilitate the validation of a bank account associated with the payee of the transaction. For example, a deposit request received from the payee of a paperless check may include account identification information that identifies a financial institution with which the payee maintains a savings, checking, or other account. The account identification information provided by the payee may also include a specific account number that can be validated. If the account associated with the payee, is maintained by issuing bank server 112, the check will be considered an “on-us check” In such a scenario, validation of the account may be as simple as identifying the account of the payee within the system of issuing bank server 112. Thus, bank validation procedures 214 may operate to identify the account associated with the payee in memory 124.

Conversely, if the account associated with the payee is maintained by a financial institution other than issuing bank server 112, the check will be considered an “interbank check” In this scenario, bank account validation procedures 214 may cause a communication to be transmitted to a recipient bank server 126 that maintains an account for the payee. The communication may include the account number provided by the payee such that the account can be validated by recipient bank server 126. Issuing bank server 112 may receive a response communication from the recipient bank server 126, indicating whether the account information could be validated. In some embodiments, the validation of the bank account by the third-party recipient bank server 126 may take several days. Accordingly, either or both of the payee and the payer may be notified of the status of the paperless check at any time.

Where the account is confirmed to be valid by recipient bank server 126, bank account validation procedures 214 may then operate to validate the paper check for payment and further processing. Alternatively, where the account is not confirmed to be valid by recipient bank server 126, bank account validation procedures 214 may operate to refuse payment on the paper check. In a particular embodiments, bank account validation procedures 214 may include further instructions for transmitting messages to either or both of the payee and the payer to notify either party of the status of the payment.

Security procedures 216 represent any suitable set of instructions, logic, or code embodied in a computer-readable storage medium or any other suitable information that operate to implement security mechanisms for preventing fraud or misuse of the paperless check. For example, security procedures 216 may operate to generate a human verification code that is transmitted to a payee to prevent the automated and unauthorized validation and/or deposit of a paperless check by a computer system. In one particular embodiment, a payee that has received a paperless check notification may be required to enter a human verification code when submitting a check deposit request to issuing bank server 112. Because the human verification code is not machine readable, correct entry of the human verification code by the payee ensures that the payee is not an automated computer system that has improperly intercepted the paperless check.

As another example, security procedures 216 may include time out procedures. For example, in a particular embodiment, the payee of a paperless check may be given a limited number of opportunities or tries to submitted validating information to issuing bank server 112. If the payee enters the wrong validation key or if an account number can not be validated, security procedures 216 may operate to decrement the finite number of tries that the payee has been given. When the payee has exceeded the allowable number of attempts to validate the paperless check, security procedures 216 may operate to lock the paperless check to prevent further processing. In a particular embodiment, security procedures 216 may operate to generate and transmit a communication to either or both of the payer and the payee to notify the parties that the paperless check could not be successfully cashed.

As another example, the time out procedures may operate to determine whether an electronic communication has sat idle for too long. For example, a payee might successfully use a link to initiate a communication session with issuing bank server 112. However, the payee might step away from his computer or become otherwise distracted. Accordingly, if the link remains open and idle for a period of time that exceeds a predetermined maximum amount of time, security procedures 216 may operate to terminate the communication session. In such a scenario, the payee may be required to click on the link again to initiate a new communication session with issuing bank server 112 before the deposit check request can be successfully transmitted to issuing bank server 112.

As another example, security procedures 216 may include time validity check procedures. For example, the unique link that is generated by link generation procedures 210 may be valid for only a predetermined amount of time. In a particular embodiment, the predetermined amount of time may be set to ninety days similar to a paper check. If the payee attempts to use the link to establish a communication session with issuing bank server 112 after the ninety day time period has passed, security procedures 216 may operate to notify the payee and/or the payer that the paperless check has expired. Either or both parties may be given the opportunity to request reissuance of the paperless check. In one particular embodiment, for example, the payer, who maintains an account with issuing bank server 112, may be required to submit a reissue check request such that a new secure link and key may be generated for the transaction.

Modifications, additions, or omissions may be made to payment logic 125 without departing from the scope of the invention. For example, check issue logic 202 may include some, all, or none of the procedures shown in FIG. 2; and deposit logic 204 may include some, all, or none of the procedures shown in FIG. 2. Either or both of check issue logic 202 and deposit logic 204 may include additional or fewer procedures than those depicted. Any suitable logic may perform the functions of payment logic 125 and the components within payment logic 125.

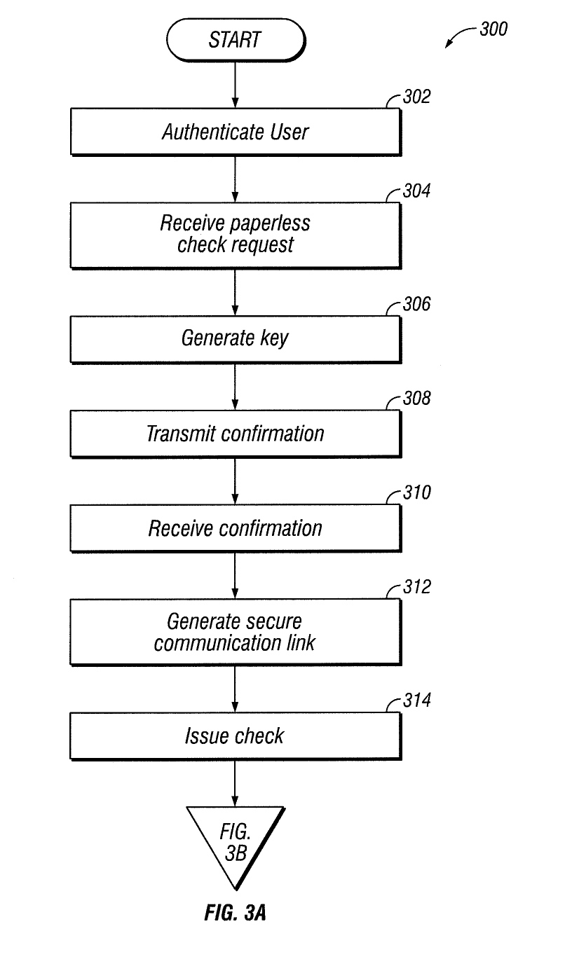

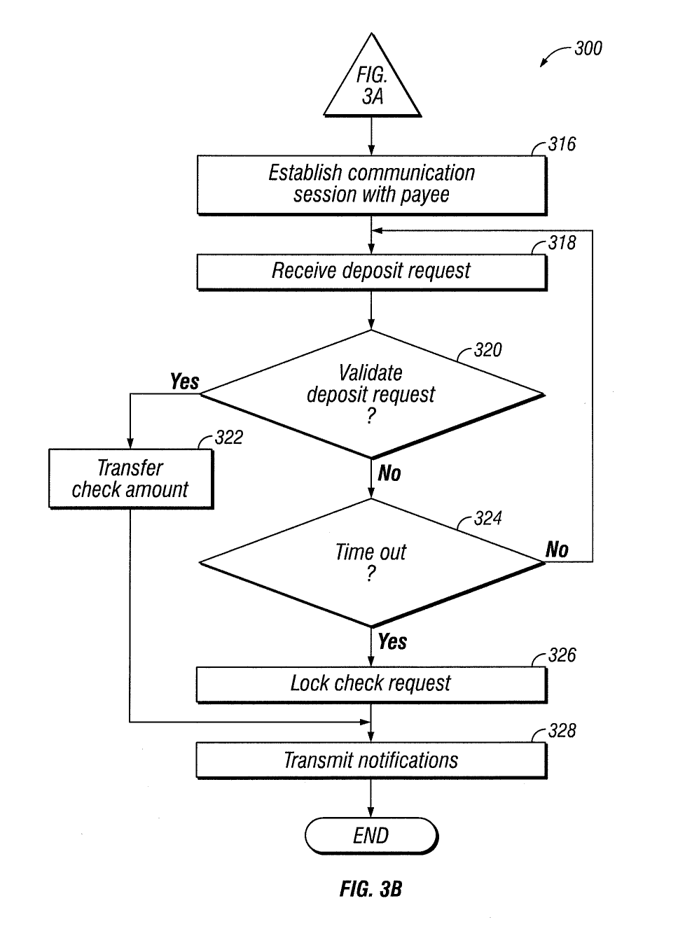

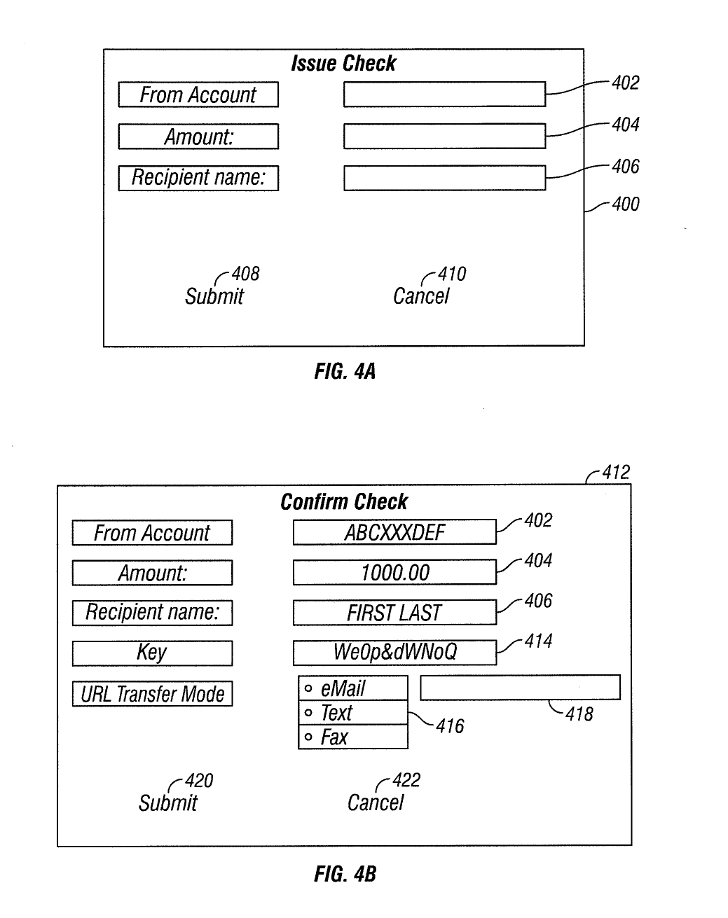

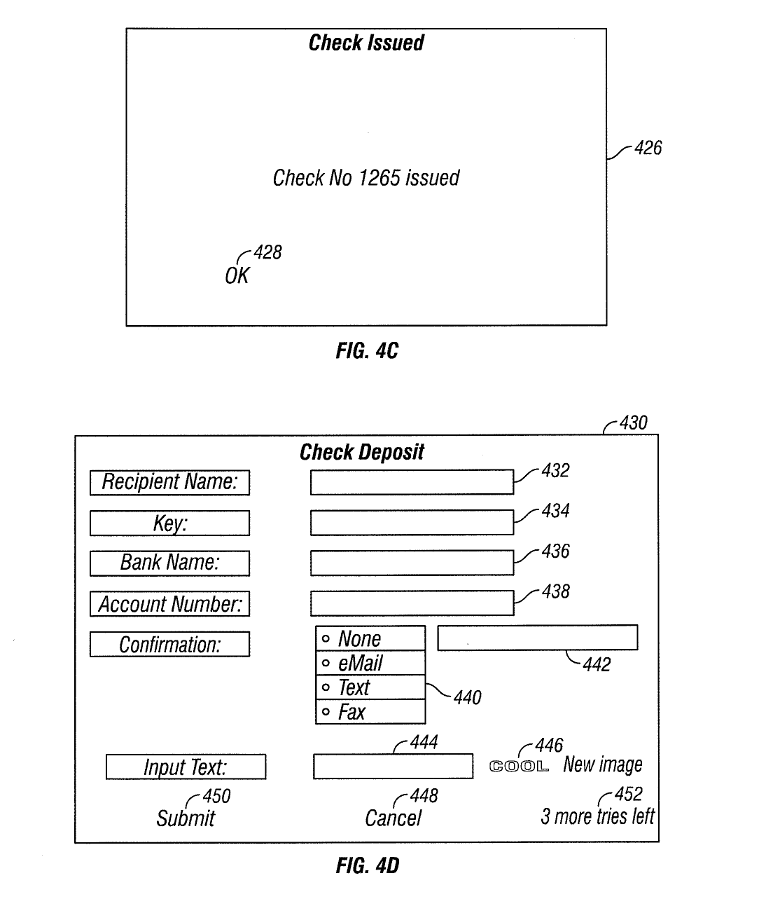

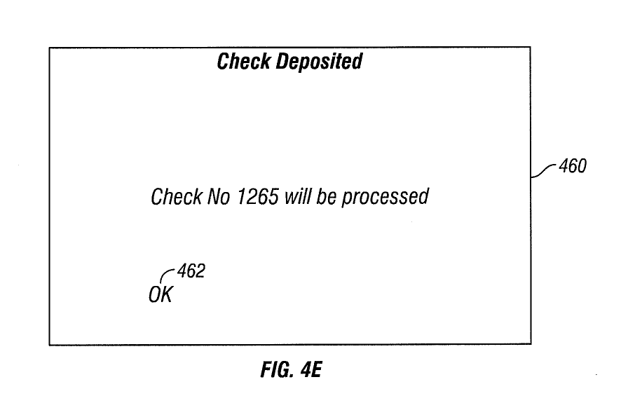

FIGS. 3A-3B are diagrams that illustrate a method 300 for the issuance and deposit of paperless checks. As will be described below, certain steps of FIGS. 3A-3B may include the receipt of data and/or the communication of data. FIGS. 4A-4E illustrates example GUIs that may be used to facilitate the input or display of data during the issuance and deposit of paperless checks. It is contemplated that the GUIs may work in conjunction with the payment system 100 described above with regard to FIG. 1. Accordingly, in certain embodiments, the GUIs may be presented on the displays of workstations 114 or mobile devices 116. The GUIs are generally operable to tailor and filter data entered by and presented to the user. The GUIs also provide the user with an efficient and user-friendly presentation of information and may comprise a plurality of displays having interactive fields, pull-down lists, and buttons operated by the user. Different embodiments of a GUI may utilize common components, information, or computer code. GUIs may include multiple levels of abstraction including groupings and boundaries. It should be understood that the term GUI may be used in the singular or in the plural to describe one or more GUIs and each of the displays of a particular GUI.

At step 302, a user that is an account holder may be authenticated by issuing bank server 112. Specifically, issuing bank server may receive user identification data from the user and may use the identification information to authenticate the user as an account holder serviced by issuing bank server 112. In one particular embodiment, for example, the account holder may be required to provide login information such as a user name and password combination or other identifying information. After the user is authenticated as a valid account holder, a particular account 124 maintained by issuing bank server 112 may be identified as belonging to the account holder.

At step 304, a request for a paperless check is received from the account holder. FIG. 4A illustrates an example GUI 400 that may be transmitted to and displayed to the account holder to facilitate the generation of the paperless check. As depicted, GUI 400 includes several fields that are populated by the account holder, who is the payer in the paperless check transaction. For example, in the illustrated embodiment, GUI 400 includes an account field 402, an amount filed 404, and a recipient field 406. In the account field 402, the payer enters a number associated with a financial account such as a checking or savings account that is associated with the payer. Alternatively, if the payer is logged into a banking application and has already been authenticated, account field 402 may include a drop down box that lists several alternative accounts that can be selected by the user to populate account field 402. For example, the payer may click on account field 402 and be presented with options such as “Checking Account” and “Savings Account” that can be selected by the user.

In the amount field 404, the payer enters a currency amount. The currency amount represents the amount of money that the payer wishes to transfer to the payee. Stated differently, the currency amount is the amount that will be drafted from the payer's account when the paperless check is deposited into the payee's account. As just one example, the payer may enter “$100”. In other embodiments, the currency amount field may also include a drop down box that may provide alternative currency amounts that may be used to automatically populate amount field 404. For example, when the payer selects the amount field 404, the payer may be presented with a list of currency amounts such as $10, $20, $50, and $100 that the payer may select from. Selection of a specific amount by the payer may result in that amount being displayed in amount field 404.

In the recipient field 406, the payer enters the name of the payee. Though a name may not be required and some other information may be used to identify the payee, the present invention contemplates that recipient field 406 does not require the payer to provide an account number for the payee. Thus, similar to a paper check, the paperless check can be issued for a payee even when the payer has no knowledge of the payee's financial institution or account information. Additionally, the payee retains control over where the paperless check will be deposited.

At any time during the issue check procedure, the payer can select the cancel button 410 to clear fields 402-406 and/or terminate the issue check procedure. However, once the account field 402, amount field 404, and recipient field 406 are populated, selection of the submit button 408 by the payer may cause the check request to be transmitted to and received by issuing bank server 112 at step 304 depicted in FIG. 3A.

At step 306, a unique key may be generated for the paperless check request. In a particular embodiment, the unique key may include string of digits that include any combination of numerals, letters, or symbols. For example, the unique key may include a string of eight to twelve digits. The unique key may be included in a confirmation message that may be transmitted to the payer at step 308. FIG. 4B illustrates an example confirmation GUI 412 that may be transmitted to and displayed to the payer/account holder for confirmation of the paperless check request data. As depicted, confirmation GUI 412 includes the account 402, amount 404, and recipient 406 fields that were populated by the payer. GUI 412 also includes a key field 414 that provides the unique key to the payer.

Additionally, confirmation GUI 412 includes a communication selection field 416 and an address field 418. In the depicted embodiment, communication selection field 416 identifies three alternative methods of communication that may be used for transmitting the paperless check to the payee. Although communication selection field 416 is depicted as including an email selector, a text selector, and a fax selector, it is contemplated that communication selection field 416 may identify any number of alternative communication methods that may be used to transmit the paperless check to the payee. Further, though communication selection field 416 is depicted as including selection buttons that are associated with each alternative method of communication, communication selection field 416 may include a drop down box from which a method of communication can be selected. After selecting a communication method, the payer enters an address, phone number, or other communication identifier into address field 418.

At any time during the confirmation procedure, the payer can select the cancel button 422 to clear fields 416-418 and/or terminate the confirmation procedure. Alternatively, once the communication selection field 416 and address field 418 are populated, selection of the submit button 420 by the payer may cause the confirmation data to be transmitted to and received by issuing bank server 112 at step 310 depicted in FIG. 3A.

At step 312, a secure communication link may be generated for the paperless check. In a particular embodiment, the secure communication link may include a web address that is uniquely associated with the paperless check request. Specifically, the web address comprises a Uniform Resource Locator of a webpage that is associated with and/or maintained by issuing bank server 112.

The paperless check may then be issued at step 314. In particular embodiments, the issuance of the paperless check may include a notification to inform the payer that the check has been issued. An example notification GUI 426 is depicted in FIG. 4C. In particular embodiments, the payer may confirm receipt of the notification by selecting the OK button 428.

In particular embodiments, issuing the paperless check at step 314 may also include transmitting the secure communications link to the payee. Specifically, the secure communications link may be transmitted using the communications method selected by the payer during the confirmation procedure. Thus, where the payer provided an email address for the payee, issuing bank server 112 may operate to transmit the secure communications link via an email message. Conversely, where the payer provided a phone number for the payee and selected the text communication method, issuing bank server 112 may operate to transmit the secure communications link via a text message. Likewise, where the payer provided a phone number and selected the fax communication method, issuing bank server 112 may operate to transmit the secure communications link via a fax. In still other embodiments, it is contemplated that the secure communications link could be provided to the payer rather than the payee, and the payer could be responsible for transmitting the secure communications link to the payee.

At some point after the transmission of the secure communications link, the method may continue as depicted in FIG. 3B. Specifically, a secure communication session may be established with the payee at step 316. In a particular embodiment, the secure communication session may be initiated by the payee. For example, issuing bank server 112 may receive a request for a secure communication session in response to the payee clicking on or otherwise selecting the secure communications link. Thus, where the secure communications link is a web address, the secure communications link may be initiated and established when the payee clicks on the web address in the email or text message. Alternatively, the secure communications link may be established when the payee inputs the web address in a web browser.

At step 318, a deposit request for the paperless check may be received from the payee. FIG. 4D illustrates an example deposit request GUI 430 that may be transmitted to and displayed to the payee to facilitate the depositing of the paperless check into an account associated with the payee. As depicted, deposit request GUI 430 includes several fields that are populated by the payee. For example, in the illustrated embodiment, deposit request GUI 430 includes a recipient field 432, a unique key field 434, a bank name field 436, an account number field 438, a communication selection field 440, a communication address field 442, and an input human verification field 444.

In the recipient field 432, the payee enters his or her the name as the payee of the paperless check to be deposited. In the key field 434, the payee enters the unique key that was transmitted to the payee at step 306 of FIG. 3A. In the bank name field 436, the payee enters the name of the financial institution that maintains the account where the payee would like the funds deposited. The account number is entered in account number field 438. Because this information is entered by payee rather than be the payer, the payee retains control over where the paperless check will be deposited, and the paperless check operates much like a paper check.

Communication selection field 440 and communication address field 442 are used by the payee to select a method for receiving a confirmation of the deposit. In the depicted embodiment, communication selection field 440 identifies four alternative methods of communication that may be used for transmitting the paperless check to the payee. Although communication selection field 440 is depicted as including a none selector, an email selector, a text selector, and a fax selector, it is contemplated that communication selection field 440 may identify any number of alternative communication methods that may be used to transmit the paperless check to the payee. Further, though communication selection field 440 is depicted as including selection buttons that are associated with each alternative method of communication, communication selection field 440 may include a drop down box from which a method of communication can be selected. After selecting a communication method, the payer enters an address, phone number, or other communication identifier into address field 442.

Human verification field 444 is used to ensure that the deposit request is submitted by a human payee and not an automated computer system that has intercepted the paperless check information. In the depicted embodiment, deposit request GUI 430 includes a human verification code 445 that is presented in a manner that is not machine readable. The payee copies the human verification code 445 into the human verification field 444.

At any time during the deposit check procedure, the payee can select the cancel button 448 to clear fields 432-444 and/or terminate the deposit check procedure. Alternatively, the payee may select submit button 450 to cause the deposit request to be transmitted to and received by issuing bank server 112 at step 318 depicted in FIG. 3A.

At step 320, a determination is made as to whether the deposit request can be validated. In a particular embodiment, validating the deposit request may include validating the unique key and the bank account of the payer. For example, issuing bank server 112 may determine whether the unique key provided by the payee in the deposit request can be matched with the unique key that was associated with a paperless check that was issued and stored in memory 124. More specifically, the unique key may point to a transaction, which may then be associated with a payer and a payer account.

In a particular embodiment, validating the deposit may also include determining whether the bank account provided by the payee is associated with the financial institution maintaining issuing bank server 112 or a financial institution other such a financial institution associated with recipient bank server 126. Where the check is an “on us” check, validating the bank account may include identifying the account of the payee in memory 124 maintained by issuing bank server 112. Conversely, where the check is an “interbank” check, validation of the bank account may require seeking third-party validation of the bank account by recipient bank server 126. For example, issuing bank server 112 may transmit a communication to a recipient bank server 126 that is associated with the bank name identified by the payee in the deposit request. The communication may request third-party validation by the recipient bank server 126 that verifies that the account number provided by the payee is correct. Issuing bank server 112 may validate the deposit request after issuing bank server 112 receives a response communication from recipient bank server 126 indicating that the account information is valid and correct. Issuing bank server 112 may then transfer funds for the paperless check to recipient bank server 126 at step 322.

However, where the deposit request cannot be validated at step 320, the method may continue to step 324 where a determination is made as to whether the deposit request has timed out. In one particular embodiment, the payee of the paperless check may be given a limited number of opportunities or tries for submitting a valid deposit request. Issuing bank server 112 may track the number of attempts made by a payee with regard to a single deposit request. Where it is determined at step 320 that a payee has not exceeded the finite number of attempts that are allowed, the payee may be directed back to deposit request GUI 430 so that the payee can make another attempt.

In a particular embodiment, deposit request GUI 430 includes an attempt indicator 452. Attempt indicator 452 may identify how many attempts are still available for submitting a valid deposit request. Each time a submitted deposit request cannot be validated and the payee is returned to the deposit request GUI 430, the attempt indicator 452 may be decremented to accurately present the remaining number of tries that remain. When the payee has exceeded the allowable number of attempts to validate the paperless check, issuing bank server 112 may operate to lock the paperless check, at step 326, to prevent further processing.

At step 328, notifications may be transmitted to the payer and/or the payee. For example, where the deposit request was validated at step 320 and the funds were transferred at step 322, a communication may be transmitted to the payer of the paperless check to notify the payer that the check has been successfully deposited by the payee. Such a communication could be transmitted by email, text message, fax, or any other suitable form of communication. Additionally, particular embodiments may include transmitting a communication to the payee to confirm that the check has been deposited in the payee's account. Such a communication could be transmitted in the method identified by the payee in the deposit request. Additionally or alternatively, the payee could be presented with a deposit confirmation GUI 460. In a particular embodiment, the payee may confirm receipt of the deposit notification by selecting OK button 462.

Conversely, where the deposit request is not validated at step 320 and has since timed out or the payee has ceased trying to deposit the paperless check, a communication may be transmitted to either or both of the payer and payee to notify the parties that the deposit has failed. Such communications may be transmitted by email, text message, fax, or any other suitable form of communication. In a particular embodiment, the communication could be transmitted in a method selected by the payer or the payee. After transmission of the appropriate notifications, the payer may be presented with or otherwise provided with a mechanism to generate a new secure communication link and unique key. Accordingly, the check may be reissued, and certain steps or a combination of the steps described above may be repeated until a deposit is validated and processed.

It is recognized that the method described in FIGS. 3A and 3B is merely one example embodiments. Various embodiments may perform some, all, or none of the steps described above, and certain embodiments may perform these steps in different orders. For example, though step 328 describes notifications sent to the payee and/or the payee after the successful or unsuccessful validation of the deposit request, it is contemplated that any appropriate notifications may be transmitted to the payee and/or payer. As just one example, it is recognized that validation of a deposit request may take several days where the check is an interbank check. In such an embodiment, either or both of the payee and payer may be notified of the status of the check as it is being processed.

Certain embodiments of the invention may provide one or more technical advantages. A technical advantage of one embodiment may be that the invention provides financial institutions and their account holders with a mechanism for the electronic transfer of funds in a manner that is similar to paper checks but more readily compliments a direct deposit feature. For example, customers of a financial institution may issue paperless checks that are transmitted to a receiving party via the Internet. In certain embodiments, customers may issue paperless checks using a mobile device such as a smart phone or other personal data assistant. As an additional advantage, certain embodiments allow the recipient of the funds to control when and where they are deposited in a manner similar to a conventional paper check. Still another advantage may that certain embodiments do not require the issuing party to provide or even have knowledge of the receiving party's bank account. As a result, fraud relating to the misuse or misappropriation of account information may be prevented. Still another technical advantage of an embodiment may be that, because the issued checks are paperless, there is less chance of the funds being lost or stolen. Additionally, security measures may be in place to prevent the fraudulent receipt and cashing of the paperless paperless checks.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method, comprising:
receiving, by a issuing bank server, a check request from a first computing device associated with a payer, the check request identifying a payee to receive monetary amount, the check request not including any account information associated with the payee;
transmitting, by the issuing bank server, a paperless check to the payee;
receiving, by the issuing bank server, a deposit request from a second computing device associated with the payee, the deposit request comprising account information associated with the payee and requesting deposit of the paperless check;
validating the deposit request received from the payee; and
electronically transferring, by the issuing bank server, the monetary amount from a first account associated with the payer to a second account associated with the payee.

2. The method of claim 1, further comprising:
prior to transmitting the paperless check to the payee:
generating, by the issuing bank server, a unique key that uniquely identifies the check request;
storing in a memory, an association between the unique key and the check request from the payer;
transmitting, by the issuing bank server, the unique key to at least one of the payee and the payer.

3. The method of claim 2, wherein:
the deposit request comprises the unique key; and
validating the deposit request comprises matching the unique key received from the payee with the unique key that is associated with the check request.

4. The method of claim 2, wherein validating the deposit request comprises determining that the unique key has not expired.

5. The method of claim 1, further comprising:
generating, by the issuing bank server, a secure communication link;
transmitting the secure communications link to the payee; and
in response to an activation of the secure communications link by the payee, establishing a secure communication session with the computing device associated with the payee, the deposit request transmitted via the secure communication session.

6. The method of claim 5, wherein the secure communication link comprises a URL.

7. The method of claim 1, wherein validating the deposit request for payment comprises validating the second account associated with the second user.

8. The method of claim 1, wherein:
the first account associated with the first user is maintained by a first financial institution; and
the second account associated with the second user is maintained by a second financial institution.

9. The method of claim 1, further comprising:
prior to receiving the check request from the first user device,
receiving login information associated with the first user; and
authenticating the login information associated with the first user.

10. The method of claim 1, wherein the deposit request further comprises a human verification code.

11. A system for issuing a paperless check, comprising:
a network interface operable to receive a check request from a first computing device associated with a payer, the check request identifying a payee to receive monetary amount, the check request not including any account information associated with the payee;
a memory operable to store data relating to the check request in an account associated with the payer;
a processor communicatively coupled to the network interface and the memory and operable to:
transmit a paperless check to the payee;
receive a deposit request from a second computing device associated with the payee, the deposit request comprising account information associated with the payee and requesting deposit of the paperless check;
validate the deposit request received from the payee; and
electronically transfer the monetary amount from a first account associated with the payer to a second account associated with the payee.

12. The payment system of claim 11, wherein, prior to transmitting the paperless check to the payee, the processor is further operable to:
generate a unique key that uniquely identifies the check request;
store the unique key in the memory;
transmit the unique key to at least one of the payee and the payer.

13. The payment system of claim 12, wherein:
the deposit request comprises the unique key; and
the processor is operable to validate the deposit request by matching the unique key received from the payee with the unique key that is associated with the check request.

14. The payment system of claim 12, wherein the processor is operable to determine that the unique key has not expired when validating the deposit request.

15. The payment system of claim 11, wherein the processor is further operable to:
generate a secure communication link;
transmit the secure communications link to the payee; and
in response to an activation of the secure communications link by the payee, establish a secure communication session with the computing device associated with the payee, the deposit request transmitted via the secure communication session.

16. The payment system of claim 15, wherein the secure communication link comprises a URL.

17. The payment system of claim 11, wherein, when validating the deposit request for payment, the processor is operable to validate the second account associated with the second user.

18. The payment system of claim 11, wherein:
the first account associated with the first user is maintained by a first financial institution; and
the second account associated with the second user is maintained by a second financial institution.

19. The payment system of claim 11, wherein, prior to receiving the check request from the first user device, the processor is further operable to:
receive login information associated with the first user; and
authenticate the login information associated with the first user.

20. The payment system of claim 11, wherein the deposit request further comprises a human verification code.

21. Logic embedded in a non-transitory computer readable storage medium and operable, when executed by a processor, to:
receive a check request from a first computing device associated with a payer, the check request identifying a payee to receive monetary amount, the check request not including any account information associated with the payee;
transmit a paperless check to the payee;
receive a deposit request from a second computing device associated with the payee, the deposit request comprising account information associated with the payee and requesting deposit of the paperless check;
validate the deposit request received from the payee; and
electronically transfer a monetary amount from a first account associated with the payer to a second account associated with the payee.

22. The logic of claim 21, further operable when executed to:
prior to transmitting the paperless check to the payee:
generate a unique key that uniquely identifies the check request;
store an association between the unique key and the check request;
transmit the unique key to at least one of the payee and the payer.

23. The logic of claim 22, wherein:
the deposit request comprises the unique key; and
validating the deposit request comprises matching the unique key received from the payee with the unique key that is associated with the check request.

24. The logic of claim 22, wherein validating the deposit request comprises determining that the unique key has not expired.

25. The logic of claim 21, further operable when executed to:
generate a secure communication link;
transmit the secure communications link to the payee; and
in response to an activation of the secure communications link by the payee, establish a secure communication session with the computing device associated with the payee, the deposit request transmitted via the secure communication session.

26. The logic of claim 25, wherein the secure communication link comprises a URL.

27. The logic of claim 21, wherein validating the deposit request for payment comprises validating the second account associated with the second user.

28. The logic of claim 21, wherein:
the first account associated with the first user is maintained by a first financial institution; and
the second account associated with the second user is maintained by a second financial institution.

29. The logic of claim 21, further operable when executed to:
prior to receiving the check request from the first user device,
receive login information associated with the first user; and
authenticate the login information associated with the first user.

30. The logic of claim 21, wherein the deposit request further comprises a human verification code.
